(19) United States
(12) Patent Application Publication
(10) Pub. No.: US 2020/0193314 A1
(43) Pub. Date: Jun. 18, 2020

(54) Causal Relationship Display System and Method

(71) Applicant: Hitachi, Ltd., Tokyo (JP)

(72) Inventors: Yuto KOJIMA, Tokyo (JP); Kazuaki TOKUNAGA, Tokyo (JP)

(21) Appl. No.: 16/561,319

(22) Filed: Sep. 5, 2019

(30) Foreign Application Priority Data
Dec. 17, 2018 (JP) 2018-235375

(51) Int. Cl. G06N 5/04; G06N 7/00

(52) U.S. Cl. CPC G06N 5/046; G06N 7/005

(57) ABSTRACT

Even when a causal relationship is complex, favorable visibility of a directed graph indicating the causal relationship is realized. In a directed graph generated and displayed by a causal relationship display system, line segments of two or more edges respectively coupled from one or more nodes to one or more different nodes are allowed to partly overlap with each other. For example, when there are two or more edges respectively coupled from one node belonging to one cause to two or more nodes respectively belonging to two or more results of the cause, line segments of the two or more edges are allowed to partly overlap with each other, and when there are two or more edges respectively coupled from two or more nodes respectively belonging to two or more causes to one node belonging to one result of the two or more causes, line segments of the two or more edges are allowed to partly overlap with each other.

### CROSS-REFERENCE TO PRIOR APPLICATION

This application relates to and claims the benefit of priority from Japanese Patent Application number 2018-235375, filed on Dec. 17, 2018 the entire disclosure of which is incorporated herein by reference.

### BACKGROUND

The present invention generally relates to a technique for displaying a causal relationship of a plurality of elements.

Examples of displaying a causal relationship include displaying a directed graph representing the causal relationship as a causal relationship network. An example of the directed graph is a directed acyclic graph (DAG).

However, a visualization technique that realizes favorable visibility of a causal relationship network having a large number of nodes is yet to be established. For example, when a simple visualization technique is adopted, although a causal relationship network illustrated in FIG. 24 may be generated and displayed, this technique has the following problems.

Since nodes and edges overlap with each other, it is difficult to recognize a causal relationship between nodes and, at the same time, visibility of nodes is low.

Since edges are drawn in all directions, there is a large amount of unnecessary information, which makes it difficult to read necessary information.

Techniques for visualizing a causal relationship network are disclosed in PLT 1, PLT 2, and PLT 3.

According to PLT 1, a node satisfying a “driver-KPI concept” is considered to be a single virtual node, and edges connecting nodes satisfying the “driver-KPI concept” are bundled by a “generic node”.

According to PLT 2, a task execution plan in a distributed environment is expressed by a DAG and, in the DAG, a row represents each distributed machine (for example, a virtual machine) and a column represents a time axis. Tasks are arranged from the left in a descending order of execution of the tasks, and parallelly-processed tasks are arranged in a same column.

According to PLT 3, by using manufacturing process data of each step as an explanatory variable and yield data of each step as an objective variable, a causal relationship between the variables is expressed as a network having a tier structure.

### PLT 1: US 2017/0154291

PLT 2: U.S. Pat. No. 9,594,601

### PLT 3: Japanese Patent Application Laid-open No. 2017-146899

### SUMMARY

According to PLT 1, while a reduction in the number of nodes improves visibility, overlapping of nodes and edges cannot be completely avoided.

According to PLT 2, since a causal relationship as a dependence relationship of tasks is simple, it is not difficult to express the causal relationship while preventing nodes and edges from overlapping with each other. PLT 2 neither discloses nor suggests expressing a complex causal relationship.

In a similar manner, PLT 3 neither discloses nor suggests expressing a complex causal relationship (for example, improving visibility of a causal relationship network having a large number of explanatory variables).

A conceivable example of a complex causal relationship is a causal relationship in which one result exists with respect to two or more causes and at least one of such two or more causes becomes a result with respect to one or more different causes.

A causal relationship network representing such a complex causal relationship may have a tier structure and may include a large number of nodes and, for example, the causal relationship network can be used in the manufacturing industry. Specifically, in an example of an environment in which a plurality of steps performed in a plant are monitored using several thousands to several tens of thousands of sensors installed in the plant, the plurality of steps may be considered a plurality of tiers and, regarding each step, various events (for example, pressure of an apparatus and a result of a sampling inspection) may be considered nodes. Even if at least one of PLT 1, PLT 2, and PLT 3 is applied to a causal relationship network representing a causal relationship in such an environment, favorable visibility cannot be realized (for example, a causal relationship among nodes belonging to a desired range cannot be displayed while maintaining a non-overlapping state of nodes and edges).

Such a problem may also arise with other kinds of directed graphs (for example, a DAG).

In a directed graph generated and displayed by a causal relationship display system, line segments of two or more edges respectively coupled from one or more nodes to one or more different nodes are allowed to partly overlap with each other. For example, when there are two or more edges respectively coupled from one node belonging to one cause to two or more nodes respectively belonging to two or more results of the cause, line segments of the two or more edges are allowed to partly overlap with each other, and when there are two or more edges respectively coupled from two or more nodes respectively belonging to two or more causes to one node belonging to one result of the two or more causes, line segments of the two or more edges are allowed to partly overlap with each other.

Even when a causal relationship is complex, favorable visibility of a directed graph indicating the causal relationship is realized.

### BRIEF DESCRIPTION OF THE DRAWINGS

FIG. 1 shows a causal relationship network according to a first embodiment;

FIG. 2 shows an example of highlighting of a part of a causal relationship network;

FIG. 3 shows a configuration of a yield prediction system;

FIG. 4 shows an example of a rule of a first kind;

FIG. 5 shows an example of a rule of a second kind;

FIG. 6 shows an example of a rule of a third kind;

FIG. 7 shows a flow of a display control process;

FIG. 8 shows a detailed flow of S702 in FIG. 7;

FIG. 9 shows a configuration of a causal relationship table;

FIG. 10 shows a configuration of a tier management table;

FIG. 11 shows a configuration of a node coordinate table;

FIG. 12 shows a configuration of an internodal distance table;

FIG. 13 shows a configuration of an edge definition table;

FIG. 14 shows an example of a total order definition according to the first embodiment;

FIG. 15 shows an example of an x coordinate calculation according to the first embodiment;

FIG. 16 shows an example of a y coordinate calculation according to the first embodiment;

FIG. 17 shows an example of a causal relationship network prior to deleting an edge;

FIG. 18 shows an example of a causal relationship network after deleting an edge;

FIG. 19 shows an example of a causal relationship network prior to adding an edge;

FIG. 20 shows an example of a causal relationship network after adding an edge;

FIG. 21 shows an example of a total order definition according to a second embodiment;

FIG. 22 shows an example of an x coordinate calculation according to the second embodiment;

FIG. 23 shows an example of a y coordinate calculation according to the second embodiment; and

FIG. 24 shows an example of a DAG to which a visualization technique according to a comparative example has been applied.

### DESCRIPTION OF EMBODIMENTS

In the following description, an “interface apparatus” may be one or more interface devices. The one or more interface devices may be at least one of the following.

One or more input/output (I/O) interface devices. An input/output (I/O) interface device is an interface device with respect to at least one of an I/O device and a remote display computer. An I/O interface device with respect to a display computer may be a communication interface device. The at least one I/O device may be any of a user interface device such as an input device including a keyboard and a pointing device and an output device such as a display device.

One or more communication interface devices. The one or more communication interface devices may be one or more communication interface devices of a same kind (for example, one or more network interface cards (NICs)) or two or more communication interface devices of different kinds (for example, an NIC and a host bus adapter (HBA)).

In addition, in the following description, a “memory” is one or more memory devices and may typically be a main storage device. The one or more memory devices in a memory may be volatile memory devices or non-volatile memory devices.

Furthermore, in the following description, a “persistent storage apparatus” is one or more persistent storage devices. A persistent storage device is, typically, a non-volatile storage device (for example, an auxiliary storage device) and may specifically be, for example, a hard disk drive (HDD) or a solid state drive (SSD).

In addition, in the following description, a “storage apparatus” may be at least a memory among a memory and a persistent storage apparatus.

Furthermore, in the following description, a “processor” is one or more processor devices. While at least one processor device is typically a microprocessor device such as a central processing unit (CPU), the processor device may be a processor device of a different kind such as a graphics processing unit (GPU). The at least one processor device may be single-core or multi-core. The at least one processor device may be a processor core. The at least one processor device may be a processor device in a broad sense of the term such as a hardware circuit (for example, a field-programmable gate array (FPGA) or an application specific integrated circuit (ASIC)) which performs a part of or all of processing.

In addition, although information that enables an output to be obtained in response to an input will be described below using expressions such as an “xxx table”, the information may be data of any structure or may be a machine learning model such as a neural network that generates an output with respect to an input. Therefore, an “xxx table” can be referred to as “xxx information”. In addition, in the following description, the configuration of each table is merely an example and a single table may be divided into two or more tables or all of or a part of two or more tables may constitute a single table.

Furthermore, in the following description, while a function will be described using expressions such as a “kkk portion”, a function may be realized when one or more computer programs are executed by a processor or may be realized by one or more hardware circuits (for example, an FPGA or an ASIC). In a case where a function is realized when a program is executed by a processor, since a prescribed process is performed while using a storage apparatus and/or an interface apparatus or the like as appropriate, the function may be considered at least a part of the processor. A process described using a function as a subject may be considered a process performed by a processor or an apparatus including the processor. A program may be installed from a program source. For example, the program source may be a program distribution computer or a computer-readable recording medium (for example, a non-transitory recording medium). The description of each function is merely an example and a plurality of functions may be consolidated into a single function or a single function may be divided into a plurality of functions.

In addition, in the following description, a “causal relationship display system” may be one or more physical computers or may be a software-defined system that is realized when at least one physical computer executes prescribed software. For example, when a computer has a display device and the computer displays information on its own display device, the computer may be a causal relationship display system. Alternatively, for example, when a first computer (for example, a server) transmits output information to a remote second computer (a display computer (for example, a client)) and the display computer displays the information (when the first computer displays information on the second computer), at least the first computer among the first computer and the second computer may be a causal relationship display system. In other words, the causal relationship display system “displaying output information” may refer to displaying output information on a display device included in a computer or a computer transmitting output information to a display computer (in the case of the latter, output information is to be displayed by the display computer).

Furthermore, in the following description, a common portion among reference characters may be used when describing elements of a same kind without distinction but reference characters may be used when describing elements of a same kind while distinguishing the elements from one another. For example, when describing tier areas without particularly distinguishing the tier areas from one another, a description of a “tier area 10” will be used, but when describing tier areas while distinguishing the individual tier areas from one another, descriptions of a “tier area 10-1”, a “tier area 10-2”, and the like may be used.

In addition, a “node” and an “edge” are terms used in directed graphs. “Node” and “edge” may be respectively replaced with other terms. For example, a “node” may be referred to as a “vertex”. An “edge” may be referred to as a “link”, a “line”, or a “branch”.

Hereinafter, several embodiments of the present invention will be described with reference to the drawings. In the following embodiments, a yield prediction system is adopted as an example of a causal relationship display system. In addition, in the following embodiments, a causal relationship network having a tier structure is adopted as an example of a directed graph (typically, a DAG or a directed acyclic graph) representing a causal relationship.

Furthermore, in the following embodiments, an x direction having a +x direction and a −x direction is a horizontal direction and a y direction having a +y direction and a −y direction is a vertical direction. Moreover, in the following embodiments, elements corresponding to nodes are variables (specifically, any of explanatory variables and objective variables).

### First Embodiment

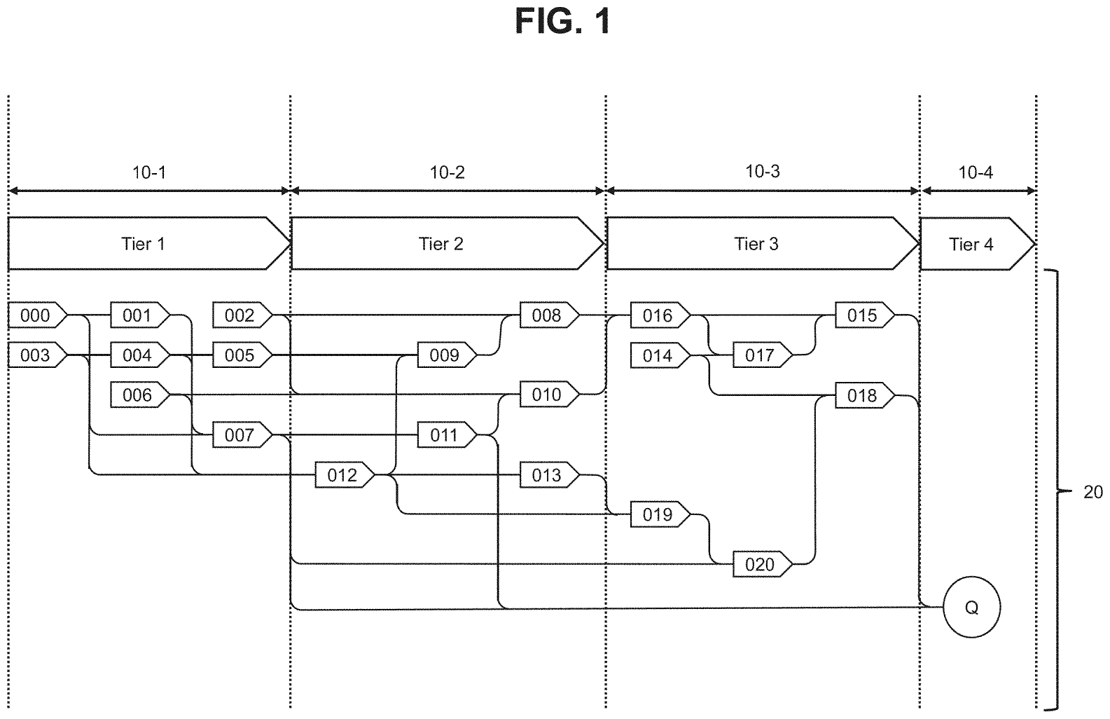

FIG. 1 shows a causal relationship network according to a first embodiment.

A yield prediction system according to the first embodiment has a graph generating portion and a user interface (UI) control portion. The graph generating portion generates, on the basis of a causal relationship table indicating causal relationships of a plurality of variables, each variable being a cause or a result, a causal relationship network constituted by a plurality of nodes respectively corresponding to the plurality of variables and a plurality of edges corresponding to the causal relationships of the plurality of variables. The UI control portion displays output information including the generated causal relationship network. A causal relationship network 20 illustrated in FIG. 1 is a causal relationship network generated by the graph generating portion and displayed (drawn) by the UI control portion.

Column-like tier areas 10-1 to 10-4 corresponding to tiers 1 to 4 (an example of a plurality of tiers) are defined along the x direction. In the present embodiment, regarding a tier α (where α is a natural number), a tier with a relatively small value of α is a cause-side tier and a tier with a relatively large value of α is a result-side tier. A sub-number in a reference numeral of a tier area corresponds to a number α of the tier corresponding to the tier area.

A plurality of nodes are arranged in the x direction and the y direction. In each of the tier areas 10-1 to 10-4, nodes are arranged which correspond to variables belonging to the tier area 10. For example, nodes 000 to 007 are arranged in the tier area 10-1. It should be noted that a width (a length in the x direction) of the tier area 10 is dependent on an arrangement of the nodes. In addition, a height (a length in the y direction) of the entire causal relationship network 20 is also dependent on an arrangement of the nodes.

In the causal relationship network 20, for example, when there are two or more edges respectively coupled from one node belonging to one cause to two or more nodes respectively belonging to two or more results of the cause, line segments of the two or more edges are allowed to partly overlap with each other. Specifically, for example, line segments (for example, line segments extending in the y direction) of two edges respectively coupled from one node 001 belonging to one cause to two nodes 007 and 012 respectively belonging to two or more results of the cause partly overlap with each other.

In addition, in the causal relationship network 20, for example, when there are two or more edges respectively coupled from two or more nodes respectively belonging to two or more causes to one node belonging to one result of the two or more causes, line segments of the two or more edges are also allowed to partly overlap with each other. Specifically, for example, line segments (for example, line segments extending in the x direction) of two edges respectively coupled from two nodes 000 and 001 respectively belonging to two causes to one node 012 belonging to one result of the two causes partly overlap with each other.

Furthermore, in the causal relationship network 20, for example, when there are two or more edges respectively coupled from two or more nodes respectively belonging to two or more causes to two or more nodes respectively belonging to two or more results respectively corresponding to the two or more causes, line segments of the two or more edges are also allowed to partly overlap with each other. Specifically, for example, line segments (for example, line segments extending in the y direction) of two edges respectively coupled from two nodes 001 and 004 respectively belonging to two causes to two nodes 012 and 007 respectively belonging to two results respectively corresponding to the two causes partly overlap with each other.

In this manner, in the present embodiment, line segments of two or more edges respectively coupled from one or more nodes to one or more different nodes are allowed to partly overlap with each other. When the object is to improve visibility, while an arrangement of edges and nodes for minimizing overlapping of edges is generally considered, the present embodiment enables the visibility of a causal relationship network to be improved by allowing partial overlapping of edges.

The present inventors have been able to derive a technical solution involving allowing partial overlapping of two or more edges as described above as a result of extensive studies has been carried out with respect to the application of causal relationship networks which led to the following findings. Specifically, for a user, it is more favorable to comprehend a causal relationship with respect to a range desired by the user by repetitively focusing on a given node and comprehending nodes that have a causal relationship with the node in focus rather than comprehending a causal relationship of all of a large number of nodes from a higher perspective.

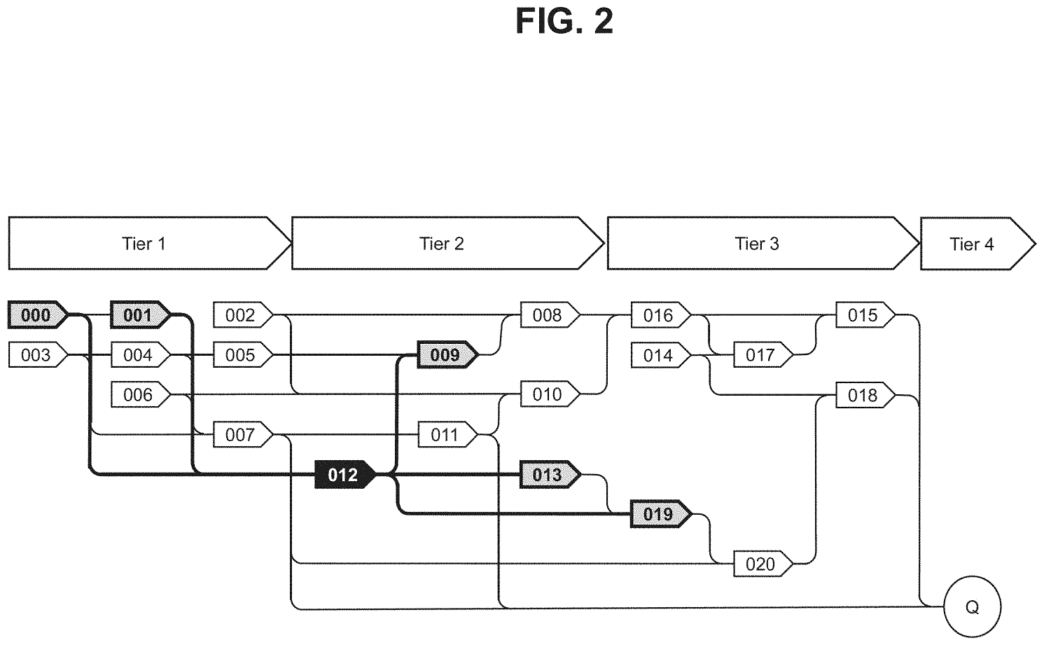

In consideration thereof, in the present embodiment, the UI control portion receives a designation of any of the nodes (a node in the user's focus of attention) in the causal relationship network 20 from the user, and highlights one or more nodes coupled to the designated node via N-number of edges (where N is a natural number) and all of the edges between the one or more nodes and the designated node. For example, when N=1 and the node 012 has been designated as illustrated in FIG. 2, all of the nodes 000, 001, 009, 013, and 019 coupled to the node 012 via one edge and all of the edges between the nodes and the designated node 012 are highlighted. Accordingly, even if the user cannot tell at a glance whether or not there is a causal relationship between nodes because two or more edges are overlapping with each other, since designating a node causes nodes in a causal relationship with the designated node to be highlighted, the user can comprehend the causal relationship between the nodes.

It should be noted that highlighting can be performed by changing attributes such as color, pattern, line type, line thickness, and the like.

In addition, the “one or more nodes coupled to the designated node via N-number of edges (where N is a natural number)” are not limited to both a cause-side node and a result-side node of the designated node and may be one of these nodes desired by the user.

Furthermore, while the value of N may be larger than 1, conceivably, the value of N is 1. This is due to the fact that since a node having a causal relationship with the designated node via other nodes (in other words, a node having an indirect causal relationship with the designated node) is excluded from targets to be highlighted, the user can tell at a glance which nodes have a direct causal relationship with the designated node. By repetitively newly designating nodes in a direct causal relationship with the designated node, a causal relationship with respect to a range desired by the user can be comprehended.

Hereinafter, the present embodiment will be described in detail.

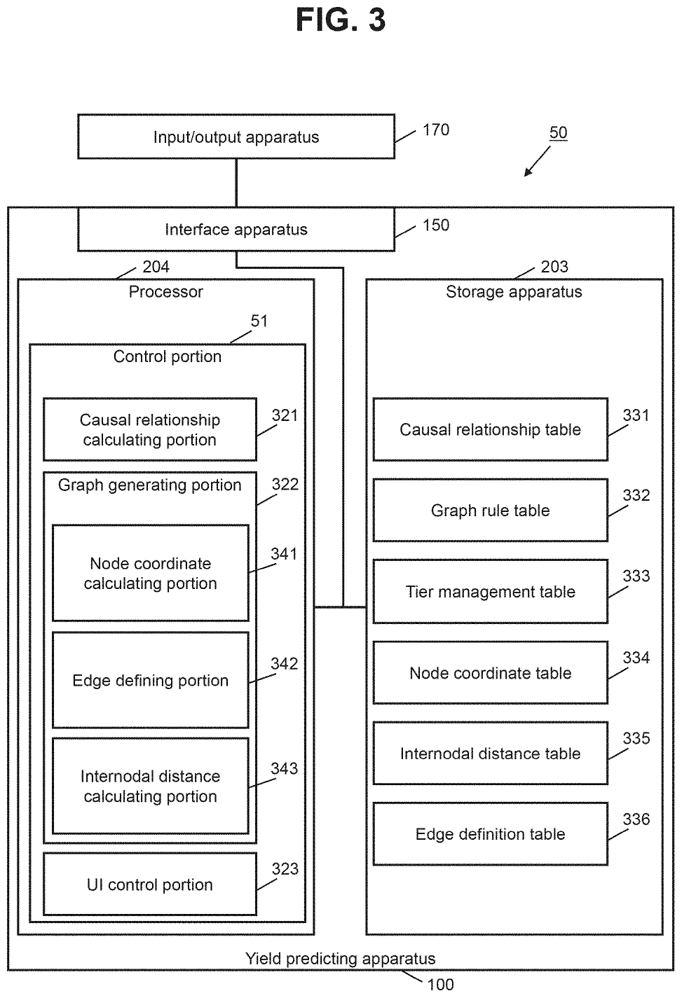

FIG. 3 shows a configuration of a yield prediction system.

A yield prediction system 50 includes a yield predicting apparatus 100 and an input/output apparatus 170 coupled to the yield predicting apparatus 100. The input/output apparatus 170 may be an example of a display computer and is a so-called input/output console which includes an input device (for example, a keyboard or a pointing device) for receiving operations by the user and a display device (for example, a liquid crystal display) for displaying output information from the yield predicting apparatus 100. A touch panel that integrates an input device and a display device may be adopted. Specifically, the input/output apparatus 170 may be a computer capable of using a Web browser and the like such as a personal computer (for example, a desktop personal computer, a laptop personal computer, or a tablet-type personal computer) or a smart phone coupled via the Internet, a local area network (LAN), a wide area network (WAN).

The yield predicting apparatus 100 may be one or more computers and has an interface apparatus 150, a storage apparatus 203, and a processor 204 coupled to the interface apparatus 150 and the storage apparatus 203. Communication with the input/output apparatus 170 is performed via the interface apparatus 150.

The storage apparatus 203 stores one or more programs to be executed by the processor 204. In addition, the storage apparatus 203 stores tables such as a causal relationship table 331, a graph rule table 332, a tier management table 333, a node coordinate table 334, an internodal distance table 335, and an edge definition table 336.

A control portion 51 is realized when the processor 204 executes the one or more programs. For example, the control portion 51 calculates a causal relationship on the basis of a manufacturing process data table (not illustrated) (for example, a table including measured values in a time series of various sensors for each product) and generates and displays a causal relationship network indicating the calculated causal relationship. Specifically, for example, the control portion 51 includes a causal relationship calculating portion 321, a graph generating portion 322, and an UI control portion 323.

The causal relationship calculating portion 321 calculates a causal relationship and stores the causal relationship table 331 indicating the causal relationship in the storage apparatus 203. For example, the causal relationship calculating portion 321 can calculate a causal relationship using the technique disclosed in PLT 3.

The graph generating portion 322 generates a causal relationship network such as that described earlier on the basis of the causal relationship table 331, the graph rule table 332, and the tier management table 333. During the generation of a causal relationship network, the node coordinate table 334, the internodal distance table 335, and the edge definition table 336 are stored in the storage apparatus 203. The graph generating portion 322 includes a node coordinate calculating portion 341 which calculates an x coordinate and a y coordinate of each node, an edge defining portion 342 which calculates coordinates and a shape of edges, and an internodal distance calculating portion 343 which calculates a distance between nodes.

On the basis of the node coordinate table 334, the internodal distance table 335, and the edge definition table 336, the UI control portion 323 displays output information including the generated causal relationship network on the input/output apparatus 170. The output information may be the causal relationship network itself or may include specific information other than the causal relationship network (for example, four display objects respectively indicating the tiers 1 to 4 as illustrated in FIG. 1).

According to the yield predicting apparatus 100 configured in this manner, the causal relationship network 20 such as that illustrated in FIG. 1 is generated and displayed. In the present embodiment, all of the following effects are realized.

(Effect 1) An x coordinate of a node enables a tier to which the node belongs and a causal relationship between the node and another node to be visually recognized.

(Effect 2) A y coordinate of an edge enables nodes to which a start point and an end point of the edge are coupled to be visually recognized.

(Effect 3) Even when there are a large number of nodes, the nodes do not overlap with each other and, at the same time, the nodes and edges also do not overlap with each other.

Realization of (Effect 1) to (Effect 3) is dependent on rules defined in the graph rule table 332 or, more specifically, rules of first to third kinds. The rule of the first kind is a rule related to nodes and contributes to realizing (Effect 1). The rule of the second kind is a rule related to edges and contributes to realizing (Effect 2). The rule of the third kind is a rule common to nodes and edges and contributes to realizing (Effect 3).

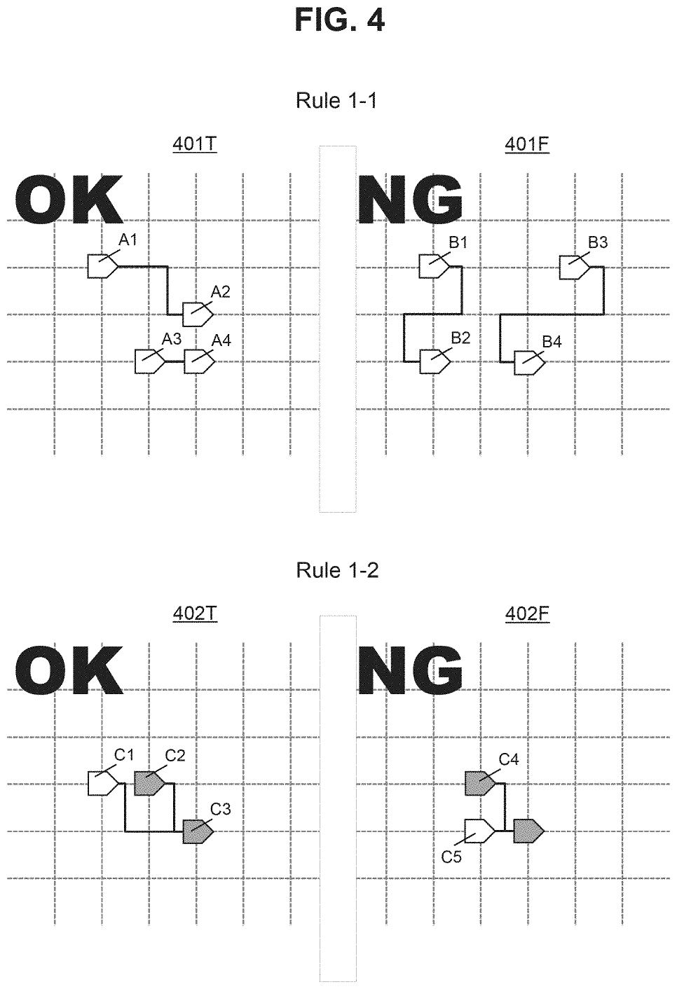

FIG. 4 shows an example of the rule of the first kind.

The rule of the first kind includes a rule 1-1 and a rule 1-2.

According to the rule 1-1, a node A1 (or A3) belonging to a cause having at least one node A2 (or A4) as a result is arranged on the −x direction side of the at least one node A2 (or A4) (reference character 401T). Therefore, an x coordinate of a node B1 (or B3) belonging to a cause never equals or exceeds an x coordinate of a node B2 (or B4) belonging to a result with respect to the cause (reference character 401F).

According to the rule 1-2, when there are a plurality of tiers into which a plurality of nodes are classified, a node C1 belonging to a cause-side tier is arranged on the −x direction side of nodes C2 and C3 belonging to a result-side tier (reference character 402T). Therefore, x coordinates of two or more nodes C4 and C5 respectively belonging to two or more different tiers are never the same (reference character 402F).

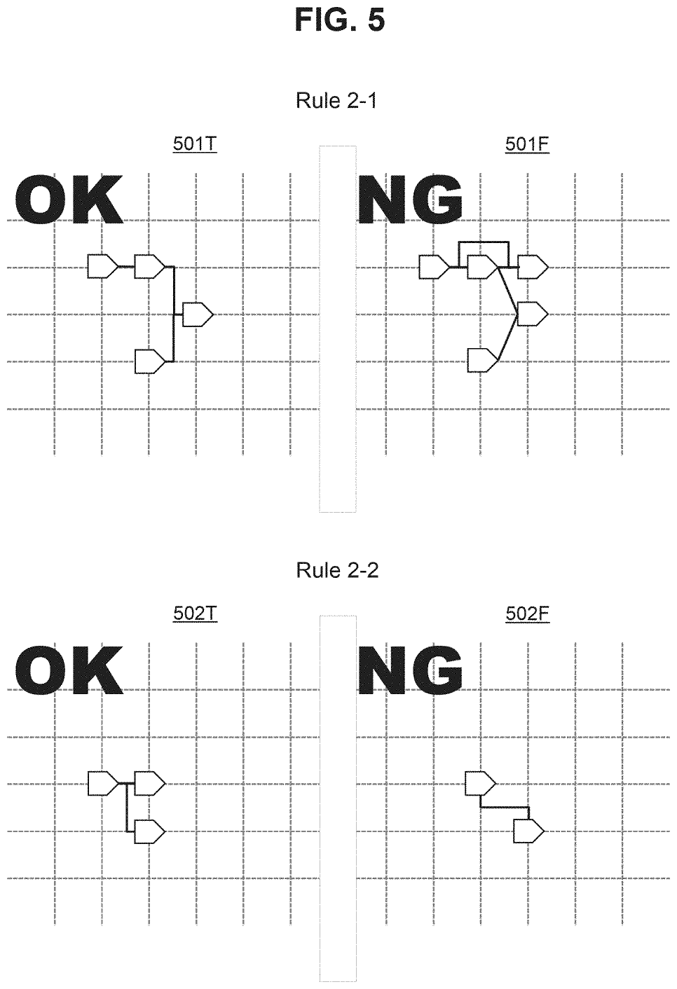

FIG. 5 shows an example of the rule of the second kind.

The rule of the second kind includes a rule 2-1 and a rule 2-2.

According to the rule 2-1, the number of bends of an edge extending parallel to the x direction from a node is 0 or 2, when the number of bends of the edge is 0, the edge is a line segment parallel to the x direction, and when the number of bends of the edge is 2, a portion other than a bent portion of the edge is constituted by a line segment parallel to the x direction and a line segment parallel to the y direction (reference character 501T). Therefore, situations where an edge is bent four times in order to straddle a node between nodes or an edge becomes a straight diagonal line in order to couple nodes arranged at different y coordinates do not occur (reference character 501F). A bent portion of an edge may have a shape other than a curved shape.

According to the rule 2-2, a line segment including a start point of an edge is coupled to the +x direction side of a node and is parallel to the x direction, and a line segment including an end point of an edge is coupled to the −x direction side of a node and is parallel to the x direction (reference character 502T). Therefore, an edge is never connected to the −y direction side or the +y direction side of a node (reference character 502F).

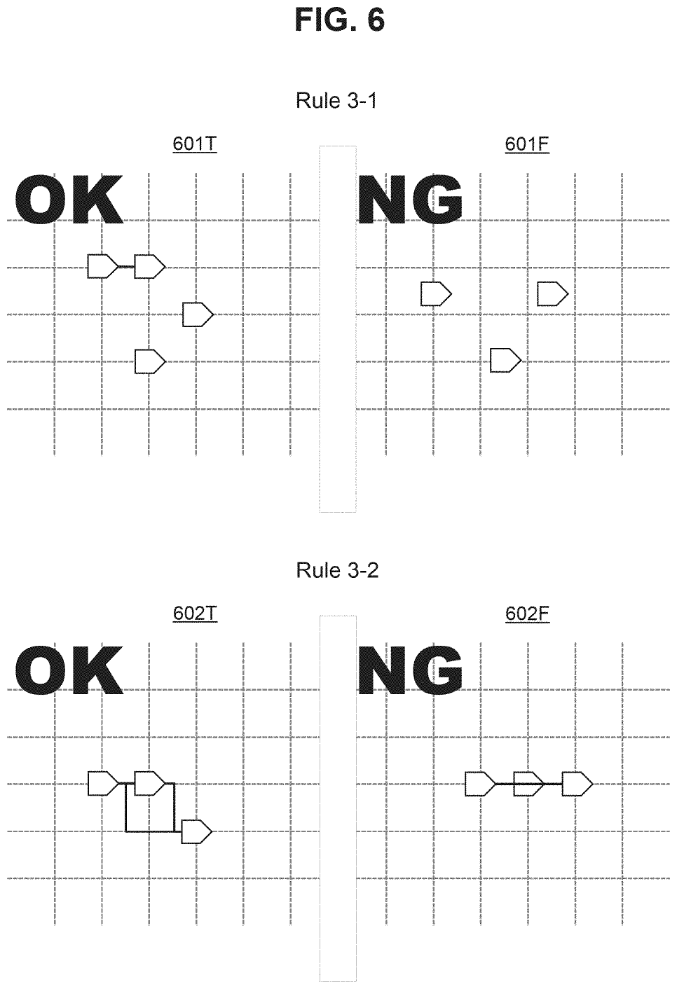

FIG. 6 shows an example of the rule of the third kind.

The rule of the third kind includes a rule 3-1 and a rule 3-2.

According to the rule 3-1, each node is arranged on a lattice point of a lattice having a lattice edge that is longer than each side of the node (reference character 601T). Therefore, a node is never arranged at positions other than lattice points (reference character 601F). A lattice point corresponds to coordinates. It should be noted that a “lattice having a lattice edge that is longer than each side of a node” may be an example of a requirement for avoiding overlapping of nodes. In addition, the lattice is a virtual lattice and may or may not be displayed together with a causal relationship network. Furthermore, at least one of x coordinate intervals and y coordinate intervals may not be uniform. Moreover, x coordinate intervals and y coordinate intervals may differ from one another.

According to the rule 3-2, nodes and edges do not overlap with each other (reference character 602T). Therefore, a situation where a node corresponding to one result and two or more nodes respectively corresponding to two or more causes having the result are positioned at a same y coordinate and all of the nodes are coupled by a straight edge extending in the x direction does not occur (reference character 602F).

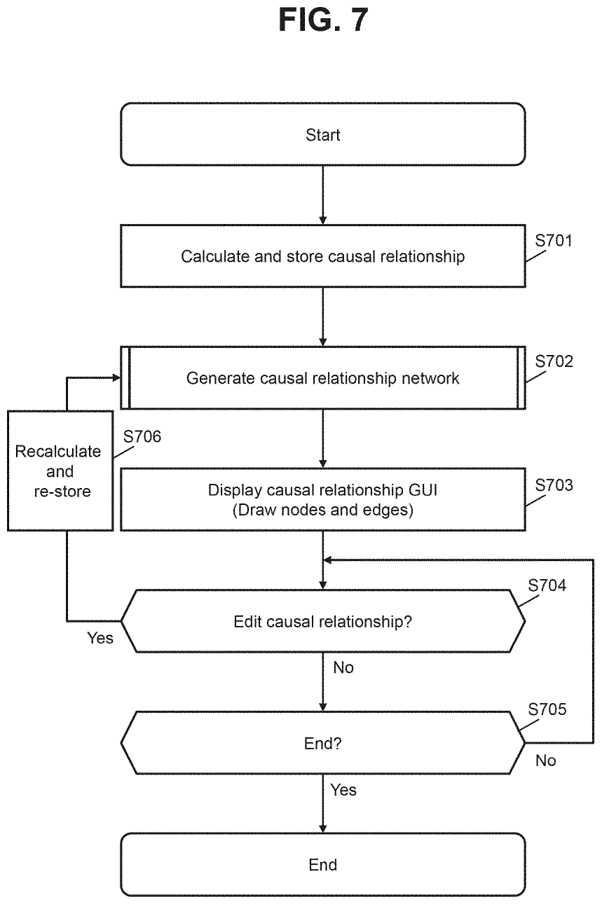

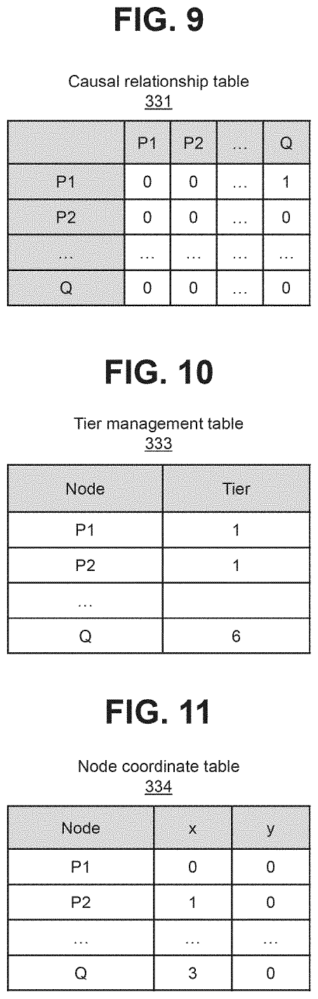

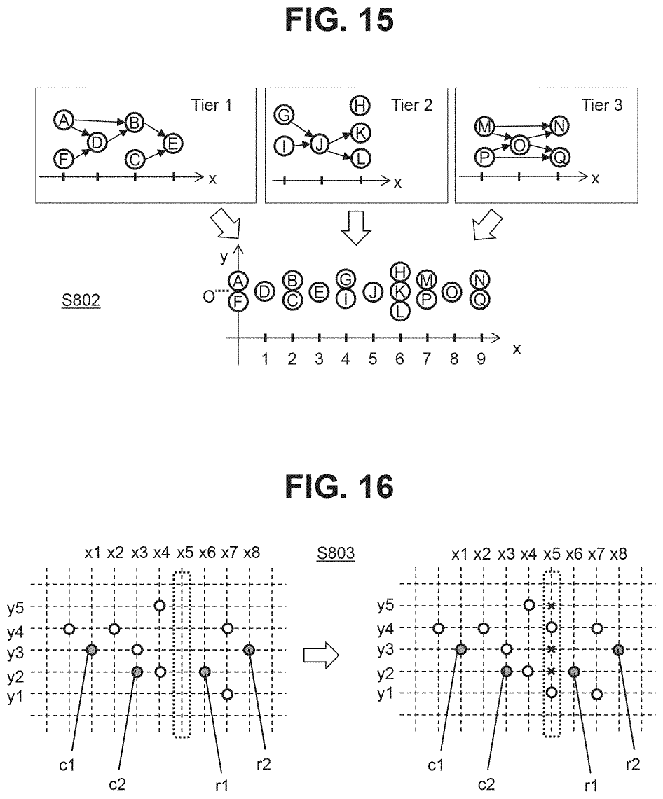

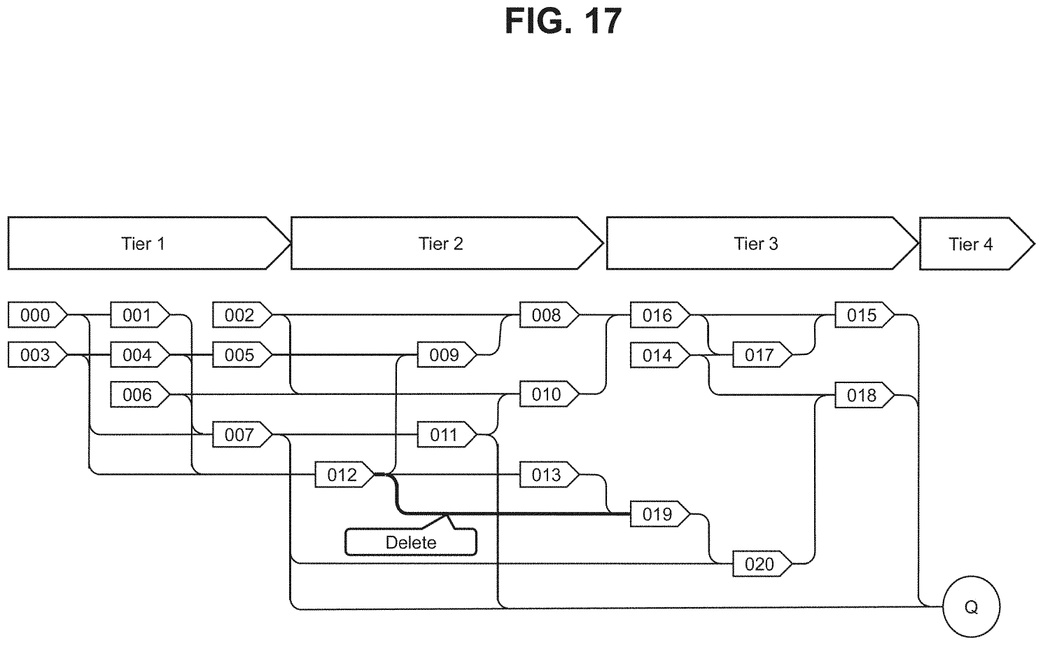

Hereinafter, an example of a process performed in the present embodiment and an example of data generated or referred to in the process will be described with reference to FIGS. 7 to 20. Although a notation (reference characters) of nodes described in the tables shown in FIGS. 9 to 13, a notation of nodes described in FIGS. 14 and 15, and a notation of nodes described in FIGS. 17 to 20 are inconsistent, the inconsistency in notations should not interfere with the understanding of the embodiment at all. This is because FIGS. 9 to 13 are diagrams showing an example of a configuration of a table, FIGS. 14 and 15 are diagrams schematically showing an example of details of a process, and FIGS. 17 to 20 are diagrams showing an example of before and after editing of a causal relationship, and understanding the respective diagrams is not dependent on the consistency of the notations of nodes.

FIG. 7 shows a flow of a display control process.

The causal relationship calculating portion 321 calculates a causal relationship on the basis of a manufacturing process data table (not illustrated) described earlier, and stores the causal relationship table 331 indicating the causal relationship in the storage apparatus 203 (S701).

The graph generating portion 322 generates a causal relationship network on the basis of the causal relationship table 331, the graph rule table 332, and the tier management table 333 (S702).

The UI control portion 323 displays a causal relationship graphical user interface (GUI) on the input/output apparatus 170 (S703). The causal relationship GUI is a GUI on which the causal relationship network generated in S702 is displayed. In S703, each node and each edge constituting the causal relationship network are drawn on the basis of the node coordinate table 334, the internodal distance table 335, and the edge definition table 336.

When the UI control portion 323 receives, via the causal relationship GUI, a user operation for editing the causal relationship by editing the causal relationship network on the GUI (S704: Yes), the UI control portion 323 once again calculates a causal relationship and stores the calculated causal relationship in the causal relationship table 331 (S706), and the graph generating portion 322 generates a causal relationship network on the basis of the re-calculated causal relationship (S702). As a result, the UI control portion 323 updates the causal relationship network on the causal relationship GUI with the generated causal relationship network. In this manner, the causal relationship calculated by the causal relationship calculating portion 321 can be edited on the basis of the user's insight.

When an end of the display control process without editing the causal relationship network on the causal relationship GUI is specified by the user (S704: No, S705: Yes), the display control process is ended.

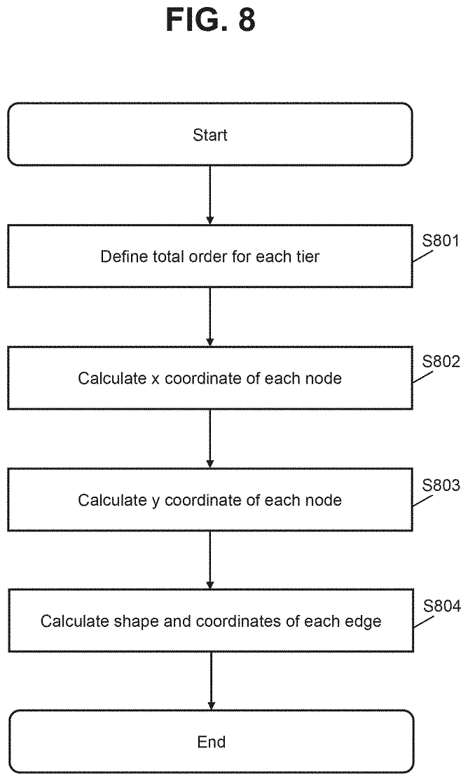

FIG. 8 shows a detailed flow of S702.

With respect to each of a plurality of tiers, the node coordinate calculating portion 341 defines a total order of all nodes belonging to the tier on the basis of the causal relationship table 331, the graph rule table 332, and the tier management table 333 (S801). The node coordinate calculating portion 341 calculates an x coordinate of each node on the basis of the total order defined in S801 with respect to each tier and the rule of the first kind indicated by the graph rule table 332 (S802). S801 and S802 contribute to (Effect 1) described earlier.

The node coordinate calculating portion 341 calculates a y coordinate of each node on the basis of the rules of the second kind and the third kind indicated by the graph rule table 332 (S803). The edge defining portion 342 calculates a shape and coordinates of each edge on the basis of the causal relationship table 331, the x coordinate and the y coordinate calculated for each node in S802 and S803, and the rules of the second kind and the third kind indicated by the graph rule table 332 (S804). S803 and S804 contribute to (Effect 2) and (Effect 3) described earlier.

FIG. 9 shows a configuration of the causal relationship table 331. In FIGS. 9 to 13, “P” corresponds to an explanatory variable (or a node corresponding to an explanatory variable) and “Q” corresponds to an objective variable (or a node corresponding to an objective variable).

The causal relationship table 331 is a table indicating a causal relationship between variables and is, for example, a so-called adjacent matrix. With respect to a combination of two variables, “1” is recorded when there is a dependence relationship between the variables but “0” is recorded when there is no dependence relationship between the variables. According to the example shown in FIG. 9, an explanatory variable P1 and an objective variable Q have a causal relationship.

FIG. 10 shows a configuration of the tier management table 333.

The tier management table 333 indicates a relationship between nodes and tiers. According to the example shown in FIG. 10, a node P1 (the explanatory variable P1) belongs to the tier 1.

FIG. 11 shows a configuration of the node coordinate table 334.

The node coordinate table 334 indicates an x coordinate and a y coordinate calculated for each node. According to the example shown in FIG. 11, the node P1 is arranged at coordinates (0, 0).

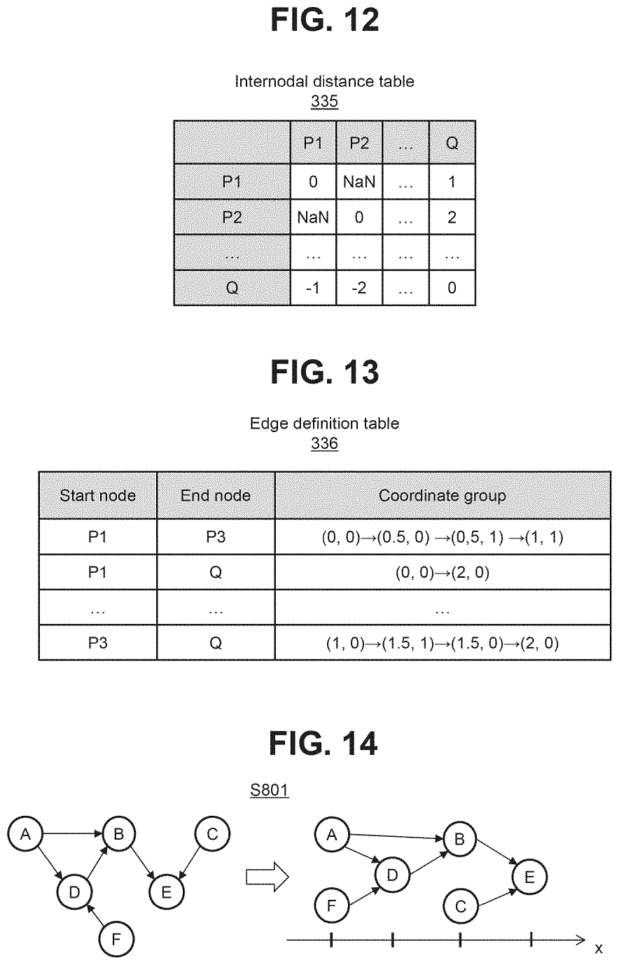

FIG. 12 shows a configuration of the internodal distance table 335.

The internodal distance table 335 indicates distances between the respective nodes and is, for example, an alternating matrix. An absolute value of α numerical value as a distance is the number of interposed edges. According to the example shown in FIG. 12, the distance between a node P2 and the node P1 is invalid (in other words, there is no causal relationship between the node P2 and the node P1) while the distance between the node P2 and a node Q is “2” (that is, two edges exist between the node P2 and the node Q or, in other words, a single different node exists between the node P2 and the node Q).

FIG. 13 shows a configuration of the edge definition table 336.

The edge definition table 336 indicates, for each edge, a start point node (a node as a start point of the edge), an end point node (a node as an end point of the edge), and a coordinate group (two or more coordinates that define a shape of the edge). When the edge is bent, the coordinate group includes coordinates of a bent point (an intermediate point). According to the example shown in FIG. 13, a definition of an edge which extends from the node P1 and which is coupled to a node P3 follows (0, 0)→(0.5, 0)→(0.5, 1)→(1, 1). This means that the edge extends horizontally toward the +x direction from a start point coordinate (0, 0) (in other words, the start point node P1), bends at coordinates (0.5, 0) (in other words, bends in the middle of a lattice edge) and extends vertically toward the +y direction, bends at coordinates (0.5, 1) and extends horizontally toward the +x direction, and is finally coupled to an end point coordinate (1, 1) (in other words, the end point node P3).

FIG. 14 shows an example of a total order definition according to the first embodiment.

A total order definition corresponds to S801 in FIG. 8. The node coordinate calculating portion 341 determines a total order for each tier so that, with respect to all nodes belonging to each tier, “each node is arranged on the −x direction side of a node that becomes a result with respect to the node”. In FIG. 14, coordinates on the x axis and an arrangement of each node indicate a total order in a tier.

FIG. 15 shows an example of an x coordinate calculation according to the first embodiment.

An x coordinate calculation corresponds to S802 in FIG. 8. First, with respect to all nodes on all tiers, the node coordinate calculating portion 341 determines a total order in accordance with a policy that “each given node follows, with respect to a node belonging to a same tier as the tier to which the given node belongs, a total order in the tier, but with respect to a node belonging to a tier that differs from the tier to which the given node belongs, the given node follows an order of a causal relationship between the tiers to which the nodes belong”. Next, with respect to all nodes, the node coordinate calculating portion 341 allocates non-negative integers beginning with zero in an ascending order of the determined total order. With respect to each node, the allocated integer is an absolute x coordinate of the node.

FIG. 16 shows an example of a y coordinate calculation according to the first embodiment.

A y coordinate calculation corresponds to S803 in FIG. 8. With respect to each of all nodes, the node coordinate calculating portion 341 determines a y coordinate in accordance with a policy that “any causal node and any result node can be reached by proceeding parallel to lattice edges while bending 0 or 2 times and at least one path along which no nodes are present can be determined”. According to the example shown in FIG. 16, a target node of which a y coordinate is to be calculated by this policy has an x coordinate of “5” and has two each of causes and results. In a situation where a causal node c1 is at (1, 3), a causal node c2 is at (3, 2), a result node r1 is at (6, 2), and a result node r2 is at (8, 3), when y coordinates range from “1” to “5”, the only y coordinates adhering to the policy described above are “1” and “4”. While any y coordinate outside of the range of “1” to “5” also adhere to the policy described above, including such y coordinates needlessly increases a height of the causal relationship network (needlessly increases a size of the causal relationship network in the y direction), which is not favorable because the number of nodes that can be displayed in a same range decreases. Therefore, the y coordinate of the target node is favorably the same or nearest to at least one of a smallest y coordinate and a largest y coordinate among y coordinates of all nodes of which the y coordinates have already been calculated (furthermore, if such a y coordinate can be selected from a range of the smallest y coordinate and the largest y coordinate, the y coordinate belongs to the range).

According to the description of FIGS. 7 to 16 presented above, the generation (S702) of a causal relationship network includes the following.

(a) Calculating an x coordinate of each of a plurality of nodes such that a node belonging to a cause is arranged on the −x direction side of a node belonging to a result of the cause.

(b) Calculating a y coordinate of each of the plurality of nodes such that an edge extending from the +x direction side of a node belonging to a cause and being coupled to the −x direction side of a node belonging to a result of the cause does not overlap with any other node and the number of bends of the edge is 0 or 2.

The node coordinate table 334 indicating an x coordinate and a y coordinate calculated for each node as described above is generated by the node coordinate calculating portion 341 and stored in the storage apparatus 203. In addition, on the basis of the node coordinate table 334, the causal relationship table 331, and the graph rule table 332, the edge defining portion 342 defines edges (defines shapes and coordinate groups of edges) with respect to between the respective nodes, generates the edge definition table 336, and stores the edge definition table 336 in the storage apparatus 203. Furthermore, the internodal distance calculating portion 343 calculates distances between the respective nodes on the basis of the edge definition table 336, generates the internodal distance table 335 indicating the distances between the respective nodes, and stores the internodal distance table 335 in the storage apparatus 203. A causal relationship network in accordance with the node coordinate table 334 and the edge definition table 336 is displayed (drawn) by the UI control portion 323 on the basis of the tier management table 333 (for example, information indicated by the node coordinate table 334, the edge definition table 336, and the tier management table 333 may be transmitted to the input/output apparatus 170 and a causal relationship network may be displayed (drawn) by a program executed by the input/output apparatus 170). When any node is designated from the displayed causal relationship network, a node with an internodal distance of N (for example, N=1) from the designated node is identified by the UI control portion 323 on the basis of the internodal distance table 335, and the identified node and the edge between the identified node and the designated node are highlighted.

As described above, with respect to a causal relationship network on a causal relationship GUI, the yield predicting apparatus 100 enables the user to edit a causal relationship indicated by the causal relationship network by allowing the user to delete a node, add a node, delete an edge, or add an edge. Specifically, for example, the following process is performed. When the UI control portion 323 receives an editing operation (deleting a node, adding a node, deleting an edge, or adding an edge) of the causal relationship network on the causal relationship GUI from the user, the UI control portion 323 updates the causal relationship indicated by the causal relationship table 331 to a causal relationship indicated by the causal relationship network after the editing. The graph generating portion 322 generates a causal relationship network indicating the causal relationship indicated by the causal relationship table 331 after the update (specifically, the graph generating portion 322 partially updates the causal relationship network). The UI control portion 323 updates the causal relationship network on the causal relationship GUI with the generated causal relationship network.

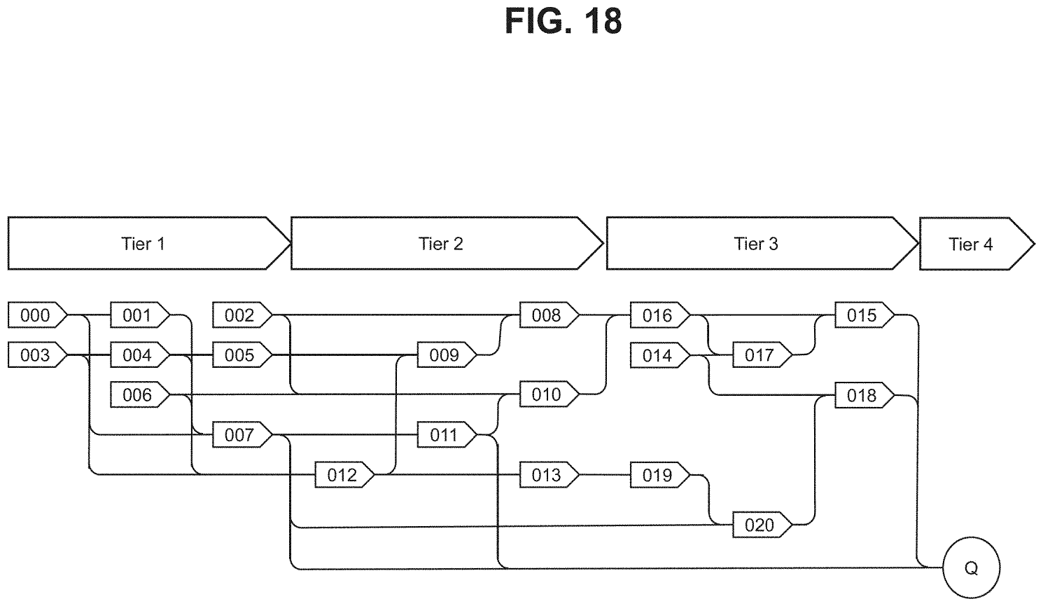

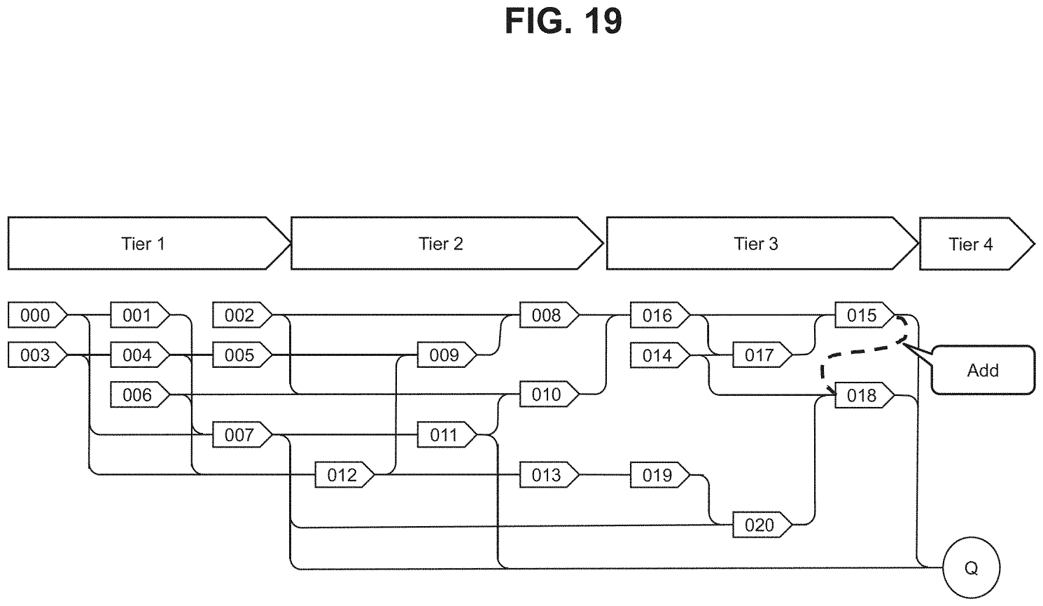

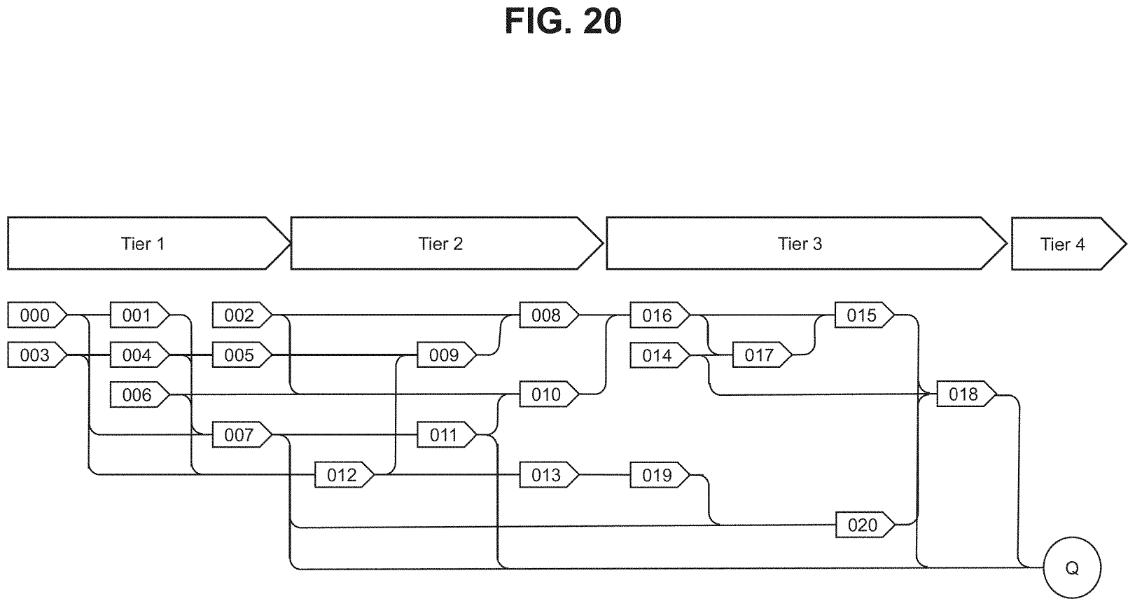

FIGS. 17 to 20 show an example of editing a causal relationship and updating a causal relationship network. For example, when an operation for deleting an edge coupled from a node 012 to a node 019 from the causal relationship network on the causal relationship GUI (a configuration of the causal relationship network is the same as that of the causal relationship network 20 shown in FIG. 1) is received by the UI control portion 323 from the user as shown in FIG. 17, the causal relationship network on the causal relationship GUI is updated by the UI control portion 323 to a causal relationship network generated (updated) by the graph generating portion 322 on the basis of a causal relationship after the deletion of the edge as shown in FIG. 18. In a similar manner, for example, when an operation for adding an edge coupled from a node 015 to a node 018 to the causal relationship network on the causal relationship GUI (a configuration of the causal relationship network is the same as that of the causal relationship network shown in FIG. 18) is received by the UI control portion 323 from the user as shown in FIG. 19, the causal relationship network on the causal relationship GUI is updated by the UI control portion 323 to a causal relationship network generated (updated) by the graph generating portion 322 on the basis of a causal relationship after the addition of the edge as shown in FIG. 20.

The generation (update) of the causal relationship network and the update of the causal relationship network on the causal relationship GUI may be performed every time a node is deleted, a node is added, an edge is deleted, or an edge is added or may be performed after completion of an editing operation that is at least one of deleting a node, adding a node, deleting an edge, and adding an edge.

### Second Embodiment

A second embodiment will now be described. In doing so, differences from the first embodiment will be mainly described and descriptions of points in common with the first embodiment will be either omitted or simplified.

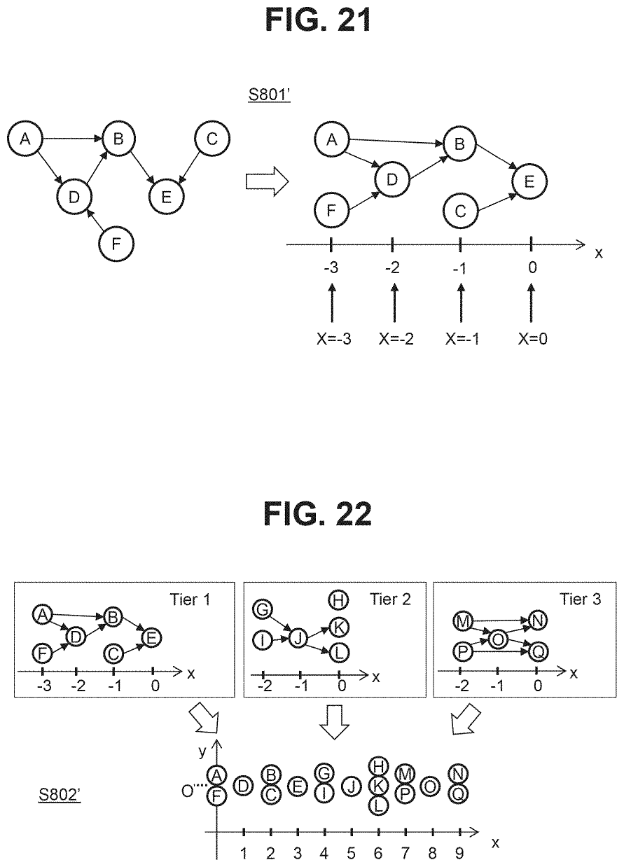

FIG. 21 shows an example of a total order definition according to the second embodiment.

The total order definition is equivalent to S801′ as S801 according to the second embodiment. In this case, for each tier, a relative x coordinate of each node belonging to the tier is calculated. The calculation of a relative x coordinate for each tier includes the following. A single tier will be described as an example (a “target tier” in the description of FIG. 21).

(a1) The node coordinate calculating portion 341 defines G_{T}, S_{T}, and X_{T}. G_{T} denotes a directed graph including a node belonging to the target tier. S_{T} denotes a set of nodes that do not have a result in G_{T}. X_{T} denotes an integer with an initial value of 0 (an example of a prescribed value).

(a2) The node coordinate calculating portion 341 repetitively adopts a relative x coordinate of a node included in S_{T} as X_{T} until S_{T} becomes an empty set, deletes a node included in S_{T} from G_{T}, and obtains S_{T} from G_{T} after deletion, and for each repetition, decrements 1 (an example of a certain value) from X_{T}.

Specifically, (a2) may be constituted by the following.

(a21) A relative x coordinate of a node included in current S_{T} is adopted as current X_{T}.

(a22) The node included in S_{T} is deleted from G_{T}.

(a23) S_{T} is identified from G_{T} after (a22).

(a24) If S_{T} after (a23) is an empty set, (a2) is ended.

(a25) If S_{T} after (a23) is not an empty set, 1 (an example of a certain value) is decremented from current X_{T} and a return is made to (a21).

According to the example shown in FIG. 21, initially, a node belonging to S_{T} is a node E and, since X_{T}=0, a relative x coordinate of the node E is “0”. In G_{T} from which the node E has been deleted, since nodes belonging to S_{T} are nodes B and C and since X_{T}=−1 due to the occurrence of one repetition, a relative x coordinate of each of the nodes B and C is “−1”.

The total order definition according to the present embodiment performs sorting in a descending order of tiers and, as a result, a sum of lengths of all edges in the x direction can be minimized. Therefore, a width of an entire causal relationship network can be kept as short as possible.

FIG. 22 shows an example of an x coordinate calculation according to the second embodiment.

The x coordinate calculation is equivalent to S802′ as S802 according to the second embodiment. The node coordinate calculating portion 341 calculates, for each of a plurality of tiers, a relative x coordinate of each of one or more nodes belonging to the tier such that a node belonging to a cause is arranged on the −x direction side of a node belonging to a result of the cause, and in accordance with an arrangement of the one or more tiers, converts a relative x coordinate calculated for each of the one or more tiers into an absolute x coordinate.

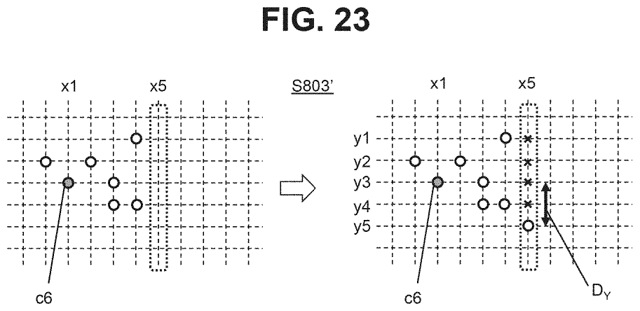

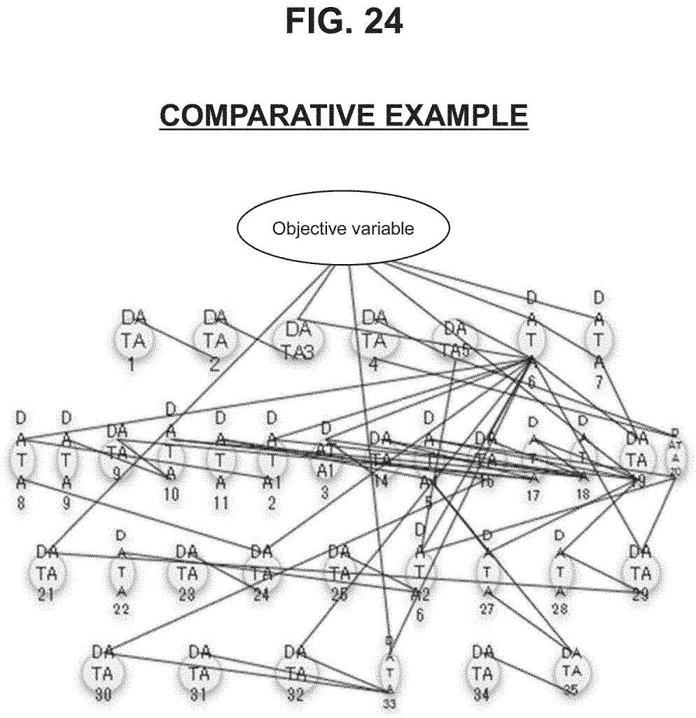

FIG. 23 shows an example of a y coordinate calculation according to the second embodiment.

The y coordinate calculation is equivalent to S803′ as S803 according to the second embodiment. In this case, the node coordinate calculating portion 341 sequentially performs the following with respect to each of a plurality of nodes starting from the node with a smallest x coordinate. A single node will be described as an example (a “target node” in the description of FIG. 23).

(b1) The node coordinate calculating portion 341 identifies, among one or more nodes respectively belonging to one or more causes having the target node as a result, a furthest ascendant node c6 which is a node arranged at a furthest x coordinate from the x coordinate of the target node.

(b2) The node coordinate calculating portion 341 identifies, among y coordinates where no node is arranged between an x coordinate “1” of the furthest ascendant node c6 and an x coordinate “5” of the target node, a y coordinate “5” which minimizes a distance between a y coordinate “3” of the furthest ascendant node c6 and a y coordinate of the target node.

(b3) The node coordinate calculating portion 341 determined the identified y coordinate “5” as the y coordinate of the target node.

A process created by interchanging “cause” and “result” and interchanging (parent) and (child) in the description of (b1) to (b3) may be adopted in place of the process of (b1) to (b3), in which case the adopted process is performed with respect to each of a plurality of nodes starting from the node with a largest x coordinate. In other words, in this case, in the description of (b1) to (b3), “result” is to be replaced by “cause”, “cause” is to be replaced by “result”, and “parent” is to be replaced by “child” (consequently, “furthest ascendant” is to be replaced by “furthest descendant”). A furthest ascendant node and a furthest descendant node are both examples of a furthest node.

The y coordinate calculation according to the present embodiment eliminates the need to perform a haphazard path search with respect to between all nodes and need only search for a path with respect to the furthest ascendant node and, consequently, an amount of calculations can be reduced (in other words, the amount of calculations can be reduced from an amount in accordance with a product of the number of nodes and the number of edges to an amount in accordance with the number of nodes).

While several embodiments have been described above, the embodiments are merely examples for describing the present invention and are not intended to limit the scope of the present invention thereto. The present invention can be implemented in various other modes. For example, the present invention can be applied in various fields in addition to the manufacturing industry. For example, a causal relationship network according to an embodiment of the present invention can be expected to be used in a causal relationship analysis between various predictive phenomena of a failure of a machine and the failure and in a causal relationship analysis between various symptoms of a patient and a disease. In addition, a DAG according to an embodiment of the present invention can be expected to be used in task scheduling in distributed computing and in transaction approval in blockchain.

What is claimed is:

1. A causal relationship display system, comprising:
a graph generating portion which generates, on the basis of causal relationship information that is information indicating causal relationships between a plurality of elements, each element being a cause or a result, a directed graph constituted by a plurality of nodes respectively corresponding to the plurality of elements and a plurality of edges corresponding to the causal relationships between the plurality of elements; and
a user interface (UI) control portion which displays output information including the generated directed graph, wherein
in the directed graph,
a first direction being a horizontal direction or a vertical direction is an x direction having a +x direction and a −x direction,
a second direction perpendicular to the first direction is a y direction having a +y direction and a −y direction, and
line segments of two or more edges respectively coupled from one or more nodes to one or more different nodes are allowed to partly overlap with each other.

2. The causal relationship display system according to claim 1, wherein
the UI control portion
receives a designation of any of the nodes in the directed graph from a user, and
highlights one or more nodes coupled to the designated node via N-number of edges (where N is a natural number) and all of the edges between the one or more nodes and the designated node.

3. The causal relationship display system according to claim 2, wherein
N=1.

4. The causal relationship display system according to claim 1, wherein
the directed graph is a directed acyclic graph (DAG),
the DAG is generated in accordance with
a rule of a first kind which is a rule related to nodes,
a rule of a second kind which is a rule related to edges, and
a rule of a third kind which is a rule common to nodes and edges,
according to the rule of the first kind, a node belonging to a cause having at least one node as a result is arranged on the −x direction side of the at least one node,
according to the rule of the second kind,
the number of bends of an edge extending parallel to the x direction from a node is 0 or 2,
when the number of bends of an edge is 0, the edge is a line segment parallel to the x direction,
when the number of bends of an edge is 2, a portion other than a bent portion of the edge is constituted by a line segment parallel to the x direction and a line segment parallel to the y direction,
a line segment including a start point of an edge is coupled to the +x direction side of a node and is parallel to the x direction,
a line segment including an end point of an edge is coupled to the −x direction side of a node and is parallel to the x direction, and
according to the rule of the third kind, nodes do not overlap with each other and, at the same time, nodes and edges do not overlap with each other.

5. The causal relationship display system according to claim 4, wherein
the DAG has a tier structure, and
according to the rule of the first kind, when there are a plurality of tiers into which the plurality of nodes are classified, a node belonging to a cause-side tier is arranged on the −x direction side of nodes belonging to a result-side tier.

6. The causal relationship display system according to claim 4, wherein
according to the rule of the third kind, a situation where nodes do not overlap with each other is realized by arranging each node on a lattice point of a lattice having a lattice edge that is longer than each side of the node, the lattice point corresponding to coordinates.

7. The causal relationship display system according to claim 1, wherein
the directed graph is a DAG, and
generating the DAG includes the following:
(a) calculating an x coordinate of each of the plurality of nodes such that a node belonging to a cause is arranged on the −x direction side of a node belonging to a result of the cause; and
(b) calculating a y coordinate of each of the plurality of nodes such that an edge extending from the +x direction side of a node belonging to a cause and being coupled to the −x direction side of a node belonging to a result of the cause does not overlap with any other node and the number of bends of the edge is 0 or 2.

8. The causal relationship display system according to claim 7, wherein
(b) includes performing, with respect to each of the plurality of nodes, the following:
(b1) identifying, among one or more nodes respectively belonging to one or more causes or results having a target node that is the relevant node as a result or a cause, a furthest ascendant node that is a node arranged at a furthest x coordinate from an x coordinate of the target node;
(b2) identifying, among y coordinates where no node is arranged between an x coordinate of the furthest ascendant node and the x coordinate of the target node, a y coordinate which minimizes a distance between a y coordinate of the furthest ascendant node and a y coordinate of the target node; and
(b3) determining the identified y coordinate as the y coordinate of the target node.

9. The causal relationship display system according to claim 7, wherein
the DAG is a causal relationship network that is a DAG with a tier structure,
with respect to each of the plurality of nodes, an x coordinate calculated in (a) is an absolute x coordinate, and
(a) involves calculating, for each of a plurality of tiers into which the plurality of nodes are classified, a relative x coordinate of each of one or more nodes belonging to the tier such that a node belonging to a cause is arranged on the −x direction side of a node belonging to a result of the cause, and in accordance with an arrangement of the one or more tiers, converting a relative x coordinate calculated for each of the one or more tiers into an absolute x coordinate.

10. The causal relationship display system according to claim 9, wherein
in (a), calculating a relative x coordinate for each of the plurality of tiers includes the following:
(a1) defining G_{T}, S_{T}, and X_{T}, where
G_{T} denotes a directed graph including a node belonging to a target tier that is the relevant tier,
S_{T} denotes a set of nodes that do not have a result in G_{T}, and
X_{T} denotes an integer with an initial value of 0; and
(a2) repetitively adopting a relative x coordinate of a node included in S_{T} as X_{T} until S_{T} becomes an empty set, deleting the node included in S_{T} from G_{T}, and obtaining S_{T} from G_{T} after deletion, and for each repetition, decrementing a certain value from X_{T}.

11. The causal relationship display system according to claim 1, wherein
the UI control portion receives a user operation for editing a causal relationship by editing the displayed directed graph,
the graph generating portion generates a directed graph on the basis of a causal relationship after the user operation, and
the UI control portion updates the displayed directed graph with the generated directed graph.

12. The causal relationship display system according to claim 1, wherein
in the generated directed graph,
the number of bends of an edge extending parallel to the x direction from a node is 0 or 2,
when the number of bends of an edge is 0, the edge is a line segment parallel to the x direction,
when the number of bends of an edge is 2, a portion other than a bent portion of the edge is constituted by a line segment parallel to the x direction and a line segment parallel to the y direction,
a line segment including a start point of an edge is coupled to the +x direction side of a node and is parallel to the x direction, and
a line segment including an end point of an edge is coupled to the −x direction side of a node and is parallel to the x direction.

13. A causal relationship display method, comprising the steps of:
generating, on the basis of causal relationship information that is information indicating causal relationships between a plurality of elements, each element being a cause or a result, a directed graph constituted by a plurality of nodes respectively corresponding to the plurality of elements and a plurality of edges corresponding to the causal relationships between the plurality of elements; and
displaying output information including the generated directed graph, wherein
in the directed graph,
a first direction being a horizontal direction or a vertical direction is an x direction having a +x direction and a −x direction,
a second direction perpendicular to the first direction is a y direction having a +y direction and a −y direction, and
line segments of two or more edges respectively coupled from one or more nodes to one or more different nodes are allowed to partly overlap with each other.

14. A computer program that causes a computer to execute the steps of:
generating, on the basis of causal relationship information that is information indicating causal relationships between a plurality of elements, each element being a cause or a result, a directed graph constituted by a plurality of nodes respectively corresponding to the plurality of elements and a plurality of edges corresponding to the causal relationships between the plurality of elements; and
displaying output information including the generated directed graph, wherein
in the directed graph,
a first direction being a horizontal direction or a vertical direction is an x direction having a +x direction and a −x direction,
a second direction perpendicular to the first direction is a y direction having a +y direction and a −y direction, and
line segments of two or more edges respectively coupled from one or more nodes to one or more different nodes are allowed to partly overlap with each other.
